(19) United States
(12) Patent Application Publication
(10) Pub. No.: US 2024/0365693 A1
(43) Pub. Date: Nov. 7, 2024

(54) SOIL-CULTIVATION DEVICE

(71) Applicant: Engelbert Rath, Jr., Pfatter (DE)

(72) Inventor: Engelbert Rath, Jr., Pfatter (DE)

(21) Appl. No.: 18/563,767

(22) PCT Filed: May 3, 2022
(86) PCT No.: PCT/EP2022/061839

§ 371 Date: Nov. 22, 2023

(30) Foreign Application Priority Data
May 28, 2021 (DE) 10 2021 113 841.8

(51) Int. Cl. A01B 39/08; A01B 39/18; A01B 63/24; A01B 63/32; A01M 21/02

(52) U.S. Cl. CPC A01B 39/085; A01B 39/18; A01B 63/245; A01B 63/32; A01M 21/02

(57) ABSTRACT

A soil-cultivation device includes a frame attachable to a tractor for movement along a direction of travel F and cultivating units mounted on the frame. Each cultivating unit has a tool carrier unit comprising soil-cultivation tools mounted on the tool carrier unit. The tool carrier unit may be detected in a direction A, −A transverse to the direction of travel F. The soil-cultivation tool is moved by of the tool carrier unit on an endlessly circulating path. The tool carrier unit can be moved at a speed which is matched to the speed of the tractor in the direction of travel F such that the soil-cultivation tools engage exclusively in areas between two successive cultivated plants of the row of cultivated plants. A direction of movement of the tools, W, forms an angle α relative to the direction of travel F, wherein 90°<α<180°.

### CROSS-REFERENCE TO RELATED APPLICATION

This application claims priority from German patent application No. DE 10 2021 113 841.8, filed May 28, 2021, the disclosure of which is hereby incorporated herein in its entirety by reference.

### FIELD

The present invention relates to a soil cultivator for mechanical weed control in rows of cultivated plants.

### BACKGROUND

Soil cultivation devices for mechanical weed control between rows of cultivated plants are known. A central component of such soil cultivation devices are hoeing devices and, in particular, hoe shares, also known as cultivator sweeps, which serve to sever or loosen the roots of weeds and similar undesirable growth in the soil. To do this, the hoe share is pulled through the soil at a shallow depth, usually using a depth guide wheel that allows the share to follow the contours of the soil.

In this case, it can occur that so many roots remain embedded in larger chunks of soil that the weeds continue to grow, particularly if the chunks of soil do not dry out in wet weather. This is the reason why hoe shares are frequently combined with harrow tines, which serve for comminuting the clods and chunks of soil detached from the hoe shares on the one hand and for pulling the weeds to the soil surface on the other hand. In both instances, the roots of the weeds are exposed, dry out and are no longer able to grow. Soil cultivation devices of this type are known, for example, from EP 0 426 960 B1, DE 35 21 785 C2 or U.S. Pat. No. 5,168,936 A.

In addition to the weed control between the individual rows of cultivated plants, however, it is also necessary to remove the weeds developing within a row of plants between adjacent cultivated plants as thoroughly as possible. DE 199 61442 A1 provides one variation of mechanical weed control within a row of cultivated plants. This document describes an apparatus for the plant position-related control of plant care devices and machines, in which the location of cultivated plants is determined during sowing, planting or subsequently, wherein the thusly recorded data of the plant positions is used by the plant care device for controlling tools such as choppers or plant protection sprayers. In this case, the tools of the plant care device can be purposefully controlled relative to the plant position or to the space between the individual plants within a row of plants.

Soil cultivation devices for weed control within a row of cultivated plants are also known from AT 522 163 A4, EP 3 610 712 A1 and DE 41 35 414 A1, wherein the tools of the soil cultivation devices essentially consist of two respective chopping elements, which can be pivoted transverse to the traveling direction and are moved toward one another during chopping. In this case, the chopping elements are controlled by means of a camera system that is coupled to a computer.

Publications DE 197 23 505 C2, WO 2008/135867 A2 and DE 10 2017 108 135 A1 disclose soil cultivation devices for weed control, in which the weed control tools carry out a rotating movement between the rows of plants. The tools are likewise controlled by means of a camera system that is coupled to a computer in this case.

However, the use of these soil cultivation devices is only feasible if the tractor is moved over the field with relatively low speed. At higher speeds, parts of the cultivated plants are damaged relatively frequently, wherein topsoil particularly is ejected in an uncontrolled manner by the soil cultivation tools that engage into the region between the cultivated plants with high speed and high momentum. As a result, the soil is depleted in the region between the cultivated plants of a row of plants and cultivated plants are damaged or completely buried by the ejected chunks of soil.

Consequently, there is a need for soil cultivation devices for mechanical weed control within a row of cultivated plants, by means of which preferably complete and reliable weed control can be carried out at a relatively high speed of the tractor during cultivation.

### SUMMARY

The invention as characterized in the claims is based on the objective of making available a soil cultivation device for mechanical weed control within a row of cultivated plants, by means of which preferably complete and reliable weed control can be carried out at a relatively high speed of the tractor during cultivation.

According to the invention, this objective is achieved by the soil cultivation device according to claim 1. Other advantageous details, aspects and embodiments of the present invention arise from the dependent claims, the description, the examples and the drawings.

The present invention provides a soil cultivation device for mechanical weed control in rows of cultivated plants. The soil cultivation device comprises a frame that can be attached to a tractor for movement along a traveling direction and at least one processing unit arranged on the frame. The processing unit has at least one tool carrier unit with at least one soil cultivation tool arranged on the tool carrier unit. At least one deflecting means is provided for deflecting the tool carrier unit, wherein the at least one deflecting means makes it possible to deflect at least a partial region of the tool carrier unit at least in a direction transverse to the traveling direction. The soil cultivation device has at least one drive means for driving the tool carrier unit, wherein the soil cultivation tool can be moved due to a movement of the tool carrier unit on an endlessly circulating path. The drive means for driving the tool carrier unit is configured and designed in such a way that the tool carrier unit can be moved with a speed, which is adapted to the speed of the tractor in the traveling direction in such a way that the soil cultivation tool engages exclusively into regions between two successive cultivated plants of the row of cultivated plants during its endlessly circulating movement. The soil cultivation tool can be moved in a tool direction in the section of its endlessly circulating path near the ground, wherein the tool direction is at an angle α relative to the traveling direction, and wherein a satisfies the condition 90°<α<180°.

The present invention is based on the idea of not moving the soil cultivation tools transverse to the traveling direction during their engagement into the soil, but rather at an angle between 90° and 180° to the traveling direction. This ensures that the soil cultivation tools carry out at least part of their movement in a direction opposite to the traveling direction of the tractor during their engagement into the soil. The speed of the soil cultivation tool relative to the ground is thereby reduced during the engagement into the soil. This in turn leads to a significantly lower probability of damages to the cultivated plants and, in particular, to reduced momentum input into the topsoil. As a result, less soil is ejected and the soil between the plants of a row of cultivated plants is preserved. These aspects, as well as the following aspects, always are subject to the condition that the drive means for driving the tool carrier unit is configured and designed in such a way that the tool carrier unit can be moved with a speed, which is adapted to the speed of the tractor in the traveling direction in such a way that the soil cultivation tool engages exclusively into regions between two successive cultivated plants of the row of cultivated plants during its endlessly circulating movement. The speed of the soil cultivation tool therefore is adapted to the speed of the tractor.

The speed with which the soil cultivation tools engage into the soil naturally depends first of all on the speed with which the tool carrier unit is driven. This speed is not freely selectable because it depends on the dimensioning of the tool carrier unit and on the number of soil cultivation tools arranged on a tool carrier unit. The selected speed of the soil cultivation tools basically is increased as the dimensions of the tool carrier unit increases and as the number of soil cultivation tools mounted on the tool carrier unit decreases. In extreme cases, a single soil cultivation tool, which is arranged on a tool carrier unit with a circumference of a few meters, is moved very fast because this single soil cultivation tool should engage into each intermediate space between the individual cultivated plants of a row of cultivated plants.

Consequently, a plurality of soil cultivation tools is arranged on a tool carrier unit in practical applications, wherein the specific number of soil cultivation tools is adapted to the circumference of the tool carrier unit. For example, the distance between the soil cultivation tools can be selected in such a way that it essentially corresponds to the distance of the cultivated plants from one another.

Irrespective of the thusly possible variety of design options for the tool carrier unit, the selection of the angle between the above-defined tool direction and the traveling direction makes it possible that the soil cultivation tools can have a reduced speed relative to the ground during their engagement into the soil. The relative speed of the soil cultivation tool basically decreases the closer the angle between the tool direction and the traveling direction lies to the value of 180°.

If this value amounts to exactly 180°, the tractor and the soil cultivation tool move in a diametrically opposed manner. In this case, the speed of the soil cultivation tool relative to the ground amounts to zero if the speed of the soil cultivation tool corresponds to the speed of the tractor. Consequently, the soil cultivation tool has a speed of zero relative to the soil over the region in which the soil cultivation tool is vertically lowered as described in greater detail below in order to thereby engage into the soil. In this case, the soil cultivation tool is in a manner of speaking plunged into the soil in a certain position and subsequently pulled out of the soil again in the same position. As mentioned above, this only applies to instances in which the angle between the tool direction and the traveling direction amounts to 180° and the speed of the soil cultivation tool is identical to the speed of the tractor.

The soil cultivation tool carries out a movement relative to the ground if these speeds remain unchanged, but the angle between the tool direction and the traveling direction is changed to a value between 180° and 90°. Any deviation from 180° leads to a decreasing movement component of the soil cultivation tool diametrically opposite to the traveling direction of the tractor and to an increasing movement component of the soil cultivation tool transverse to the traveling direction, i.e. in a direction transverse to the row of cultivated plants. If the processing unit is positioned accordingly, this movement component of the soil cultivation tool extends through the intermediate space between two successive cultivated plants transverse to the traveling direction.

In this context, it is indicative that the speed of the soil cultivation tool relative to the ground is very low because the majority of the movement component of the soil cultivation tool still extends diametrically opposite to the traveling direction of the tractor. The soil cultivation tool therefore engages into the soil slowly and with little momentum, which in turn leads to the above-described advantage that less soil is ejected and the soil between the plants of a row of cultivated plants is preserved.

An even greater advantage can be seen in the fact that the tractor can be moved forward with a significantly higher speed than in solutions known from the prior art. The speed of the tool carrier and therefore the speed of the soil cultivation tools can be easily adapted to the speed of the tractor over a broad range. However, the relative speed of the soil cultivation tool during its engagement and movement through the ground remains slow and is still associated with the above-described advantages even if the speed is increased.

It is known from the prior art and goes without saying for a person skilled in the art that the inventive soil cultivation device for mechanical weed control in rows of cultivated plants is provided with additional components that allow soil cultivation for controlling weeds and at the same time serve for protecting the cultivated plants. These components usually consist of cameras that detect the individual plants and forward this image information to a computer unit for analysis. A separate camera may be used for each row of plants in this case, but other known solutions comprise a camera that records multiple rows of cultivated plants. The cameras are positioned and mounted in accordance with the prior art.

Furthermore, the tractor is provided with customary speedometers and GPS systems that make it possible to exactly determine the position, the moving direction and the speed of the tractor. The tractor may also be equipped with a commercially available RTK system. An RTK receiver module is installed on the tractor in this case. The signal of the GPS satellite is transmitted to a base station that processes the signal and forwards it to a receiver installed on the tractor with RTK level corrections. In this way, the position and the speed of the tractor can be determined much more accurately than with conventional GPS navigation.

Customary means for determining the exact position of the soil cultivation tools are ultimately also provided. In the simplest case, a hexagon socket screw is for this purpose provided on the tool carrier unit at a predefined distance from each soil cultivation tool arranged on the tool carrier unit, wherein the exact position of said hexagon socket screws can be determined by means of a corresponding sensor, particularly a magneto-inductive sensor. This makes it possible to correspondingly determine the exact position of the soil cultivation tools.

All data, i.e., camera recordings of the plants, position and speed data of the tractor and position data of the soil cultivation tools, is forwarded to a computer unit, which is advantageously arranged on the tractor, and processed therein.

In this way, it is determined, for example, whether the cultivated plants are regularly spaced apart from one another at any point in time during the soil cultivation. If the computer unit determines that the cultivated plants are irregularly spaced apart from one another or that the position of the plants cannot be reliably determined due to excessive weed growth, the computer unit transmits instructions to the processing unit assigned to the corresponding row of plants to stop cultivation. For example, the corresponding processing unit is subsequently pivoted vertically upward such that the soil cultivation tools arranged on this processing unit are no longer in contact with the ground.

At the beginning of the soil cultivation process, the position of the tractor and of each processing unit relative to the plants of the row of plants assigned to this processing unit is likewise determined with the aid of the aforementioned sensors and positioning means. The position of the processing unit in the traveling direction is changed prior to the start of cultivation in such a way that the soil cultivation tools arranged on this processing unit are positioned in a region between the cultivated plants. At this point in time, the tool carrier unit is still oriented parallel to the row of plants, i.e. the angle between the tool direction and the traveling direction amounts to 180°. After the processing unit has been positioned in the traveling direction, at least a partial region of the tool carrier unit is deflected in a direction transverse to the traveling direction such that the angle between the tool direction and the traveling direction is adjusted to a value between 90° and 180°. According to the invention, at least one deflecting means is provided for this purpose, wherein the design of said deflecting means is described in greater detail below.

The frame of the soil cultivator preferably has a conventional three-point tower, by means of which the connection of the soil cultivator to a three-point linkage of the tractor can be made.

The tool carrier unit preferably is realized in the form of a circular disk, wherein the drive means for driving the tool carrier unit is a drive means for driving the circular disk, wherein the circular disk is set in rotation by the drive means, wherein the deflecting means for deflecting the tool carrier unit is a deflecting means for deflecting the circular disk, wherein the circular disk can be deflected in a direction transverse to the traveling direction by the deflecting means, wherein the deflection of the circular disk can be realized in such a way that the circular disk is at an angle β relative to the traveling direction, wherein β satisfies the condition 90°<β<180°, and wherein α=β applies. According to this embodiment, the soil cultivation tools are mounted on a circular disk. A person skilled in the art can clearly see that this does not concern a circular disk in the mathematical sense, but rather a straight circular cylinder of small height. The term “circular disk” is used to this effect in the context of the present description. The circular disk is oriented vertically, i.e. it vertically stands on the ground with its radius oriented vertically. The circular disk initially is aligned parallel to the row of plants (β=180°) and then pivoted (90°<β<180°) perpendicular to the ground about its diameter by the deflecting means. At the beginning of cultivation, the circular disk is set in rotation in such a way that the angle between the tool direction and the traveling direction satisfies the condition 90°<α<180°. Consequently, α=β also applies.

A circular disk, particularly a circular disk of metal, represents an extremely robust form of a tool carrier unit that can be easily manufactured and installed. The soil cultivation tools may be distributed over the circumference of the circular disk and rigidly connected, e.g., welded, to the circular disk such that they point radially outward.

It is particularly preferred to furthermore provide a circular guide disk, wherein the soil cultivation tool is guided by a recess provided in the circular guide disk. The circular disk and the circular guide disk have identical diameters. The centers of the circular disk and the circular guide disk lie in a common plane perpendicular to the ground, wherein the aforementioned radius of the circular disk, which is oriented vertically on the ground, also lies in this plane. The two circular disks merely are arranged slightly offset to one another and largely overlap in the projection perpendicular to the surface of the circular disk. The soil cultivation tool or the soil cultivation tools are movably mounted on the circular disk, e.g., with the aid of a ball joint. The circular guide disk has a number of recesses that corresponds to the number of soil cultivation tools. The spacing between these recesses is identical to the spacing between the mounting points of the soil cultivation tools on the circular disk. Each of the soil cultivation tools mounted on the circular disk is guided by one respective recess of the circular guide disk. As a result, the soil cultivation tools do not point radially outward during a rotation of the circular disk, but rather are always oriented in the direction of the ground. The speed of the soil cultivation tools therefore decreases due to the reduction of the circumference of the circular path, on which the part of the soil cultivation tools engaging into the soil moves. The soil cultivation tools in effect move with a slower speed, which in turn leads to reduced momentum input upon soil contact.

The design principle and the interaction between the two above-described disks, i.e., the circular disk and the circular guide disk, can be described as analogous to the suspension of the reel reaping device of a combine harvester and is quite familiar to a person skilled in the art.

According to another preferred embodiment, the tool carrier unit is a belt running gear, wherein the belt running gear comprises an endlessly circulating running gear belt, two deflection rollers and an elongate deflection roller connecting means for rigidly connecting the two deflection rollers, wherein the soil cultivation tool is arranged on the running gear belt, wherein the drive means for driving the tool carrier unit is a drive means for driving the belt running gear, wherein the at least one deflecting means for deflecting the tool carrier unit is a deflecting means for deflecting the belt running gear, and wherein the belt running gear can be deflected in a direction transverse to the traveling direction over at least a partial circumferential region of the circulating running gear belt. A belt running gear has the particular advantage that the length of the circulating running gear belt can be varied within broad ranges, which in turn leads to increased flexibility in the definition and adaptation of the speed of the running gear belt to the speed of the tractor.

The deflecting means for deflecting the belt running gear is a deflecting means for deflecting the running gear belt and/or a deflecting means for deflecting the deflection roller connecting means. A pivoting movement of the entire belt running gear over the row of cultivated plants can be realized by deflecting only the deflection roller connecting means. The deflection roller connecting means remains aligned parallel to the row of plants during a deflection of only the running gear belt. The engagement of the soil cultivation tools into the region between the cultivated plants of a row of plants can be achieved due to the purposeful deflection of the running gear belt. Both types of deflection may be combined with one another.

It is particularly preferred that the deflecting means for deflecting the belt running gear is a deflecting means for deflecting the deflection roller connecting means, wherein the deflection of the deflection roller connecting means can be realized in such a way that the elongate deflection roller connecting means is at an angle γ relative to the traveling direction, wherein γ satisfies the condition 90°<γ<180°, and wherein α=γ applies. The deflection roller connecting means and therefore also the linear parts of the running gear belt are initially aligned parallel to the row of plants (γ=180°). The deflection roller connecting means is then pivoted parallel to the ground by the deflecting means in such a way that the deflection roller connecting means forms an angle of 90°<γ<180° with the row of cultivated plants after the pivoting movement. At the beginning of cultivation, the running gear belt is set into an endlessly circulating movement in such a way that the angle between the tool direction and the traveling direction satisfies the condition 90°<α<180°. Consequently, α=γ also applies.

According to another preferred embodiment, a plurality of soil cultivation tools is arranged on the tool carrier unit, wherein the soil cultivation tools preferably are arranged on the tool carrier unit at a constant distance from one another. It was already explained above that, at a given length of the running gear belt the selected speed of the soil cultivation tools needs to be increased if fewer soil cultivation tools are mounted on the running gear belt. In extreme cases, a single soil cultivation tool which is arranged on a running gear belt with a length of a few meters has to be moved very fast because this single soil cultivation tool should engage into each intermediate space between the individual cultivated plants of a row of cultivated plants. It is therefore advantageous to arrange a plurality of soil cultivation tools on a running gear belt in practical applications, wherein the specific number of soil cultivation tools is adapted to the length of the running gear belt. For example, the distance between the soil cultivation tools may be chosen in such a way that it essentially corresponds to the distance of the cultivated plants from one another.

For example, a depth control wheel for controlling the working depth, which is arranged on the frame attached to the tractor, may be used as drive means for driving the tool carrier unit. In this case, the depth control wheel is mechanically coupled to the tool carrier unit. For example, the depth control wheel is mechanically coupled to a deflection roller of the belt running gear in such a way that the depth control wheel and the deflection roller can be moved with the same angular speed.

A drive belt running gear, which is arranged on the frame attached to the tractor, furthermore may be used as drive means for driving the tool carrier unit, wherein a means for driving the drive belt running gear is provided and/or the drive belt running gear is in contact with the ground over a partial circumferential region of the drive belt running gear. For example, the drive belt running gear may be realized in the form of a link chain, a gear chain, a crawler chain or wire cables. If the drive belt running gear is in contact with the ground, the drive belt running gear is moved due to its friction with the ground. The drive therefore is realized due to the movement of the tractor. However, the drive belt running gear may also be driven by any type of motor such as a gasoline engine, an oil engine or an electric motor, wherein this has the advantage that any type of potential slippage between the drive belt running gear and the ground is prevented. The drive belt running gear is mechanically coupled to and drives the tool carrier unit or the tool carrier units.

It is particularly preferred that the drive unit for driving the tool carrier unit is a motor, particularly an electric motor. This embodiment provides extremely high flexibility with respect to the selectable speed and makes it possible to regulate and control the speed in a particularly simple manner.

According to a particularly preferred embodiment of the present invention, a plurality of processing units with a plurality of tool carrier units is arranged on the frame. This embodiment takes into account the fact that modern agricultural devices have a width of several meters such that multiple rows of cultivated plants can be cultivated simultaneously in one pass. The individual tool carrier units can be operated with different speeds that are individually adapted to the distances between the plants. The control by means of the computer unit also makes it possible for the tool carrier units to assume different angles relative to the traveling direction. The individual tool carrier units ultimately can be pivoted vertically upward in case cultivation of the corresponding row of plants is not possible due to the specific circumstances in this row.

It is preferred to provide at least one camera and at least one computer unit, wherein the computer unit is designed and configured for processing the image information recorded by the camera. The advantages associated with a camera and a computer unit were already addressed in detail above. However, it should be clarified that the present invention can also be realized without these optionally provided auxiliary means. According to the invention, it is merely required that the tool carrier unit can be moved with a speed, which is adapted to the speed of the tractor in the traveling direction in such a way that the soil cultivation tool engages exclusively into regions between two successive cultivated plants of the row of cultivated plants during its endlessly circulating movement. The above-described advantages associated with the movement of the soil cultivation tool in a tool direction in the section of its endlessly circulating path near the ground are preserved as long as the tool direction includes an angle α with the traveling direction, wherein a satisfies the condition 90°<α<180°.

The soil cultivation tools preferably are realized in the form of harrow tines or cultivator sweeps. Harrow tines serve for pulling weeds to the soil surface. Furthermore, harrow tines serve for breaking up consolidated soil in a region located relatively close to the cultivated plants.

According to another preferred embodiment, the at least one processing unit has at least one first hydraulic actuating means, wherein the tool carrier unit can be moved parallel to the traveling direction by the first hydraulic actuating means. As mentioned above, the position of the tractor and of each processing unit relative to the plants of the row of plants assigned to this processing unit is determined with the aid of sensors and positioning means at the beginning of a soil cultivation process. The position of the tool carrier unit in the traveling direction is changed prior to the beginning of cultivation in such a way that the soil cultivation tools arranged on this tool carrier unit are positioned in a region between the cultivated plants. This is realized with the aforementioned first hydraulic actuating means, which is able to move the tool carrier unit parallel to the traveling direction. However, such a movement of the tool carrier unit parallel to the traveling direction can also be carried out during soil cultivation. The first hydraulic actuating means is connected to the computer unit and can reposition the tool carrier unit correspondingly during cultivation based on the plant positions detected by the cameras. The positioning preferably takes place over a distance of no more than ±50 cm in the traveling direction starting from a zero position.

The at least one processing unit preferably has at least one second hydraulic actuating means, wherein at least a partial region of the tool carrier unit can be moved in a direction transverse to the traveling direction by the second hydraulic actuating means. As mentioned above, the deflection of the belt running gear can be realized by deflecting the running gear belt and/or by deflecting the deflection roller connecting means. A deflection of only the deflection roller connecting means makes it possible to realize a pivoting movement of the entire belt running gear over the row of cultivated plants. A second hydraulic actuating means makes it possible to realize this pivoting movement in a particularly simple and advantageous manner.

It is particularly preferred that the at least one processing unit has at least one third hydraulic actuating means, wherein the tool carrier unit can be moved in the vertical direction by the third hydraulic actuating means. A movement of the tool carrier unit in the vertical direction is necessary, for example, if the camera system determines that the plants are spaced apart from one another by irregular distances or that the position of the plants cannot be reliably determined due to excessive weed growth. In this case, the computer unit transmits instructions for adjusting the cultivation to the processing unit assigned to the corresponding row of plants. As a result, for example, the corresponding processing unit is pivoted vertically upward such that the soil cultivation tools arranged on this processing unit no longer come in contact with the ground. A third hydraulic actuating means makes it possible to pivot the corresponding processing unit vertically upward in a particularly simple manner.

The deflecting means required for deflecting the tool carrier unit may be realized in different ways. The deflection of a circular disk, as well as the deflection of a belt running gear, can be realized with the aid of the second hydraulic actuating means.

Any type of deflecting means and also any type of drive for the deflecting means may be used in connection with any type of tool carrier unit in order to deflect this tool carrier unit. The deflecting means therefore may be operated hydraulically, pneumatically, electrically or even manually. This means that the tool carrier unit basically can be deflected manually, as well as by any type of motor that acts upon the deflecting means directly or via an actuating means.

It was already mentioned above that the deflection of the belt running gear may take place as a result of deflecting the running gear belt and/or as a result of deflecting the deflection roller connecting means. The deflection roller connecting means remains aligned parallel to the row of plants during a deflection of only the running gear belt. The engagement of the soil cultivation tools into the region between the cultivated plants of a row of plants is realized due to the purposeful deflection of the running gear belt. Both types of deflection may be combined with one another.

The deflecting means required for deflecting the belt running gear may be realized in different ways. For example, the deflecting means for deflecting the tool carrier unit may be a crowning plate. A correspondingly shaped crowning plate makes it possible to deflect the running gear belt in a direction transverse to the traveling direction, i.e. transverse to the row of plants, but also in a direction vertically downward or upward. Since the running gear belt is guided along the crowning plate, the soil cultivation tools mounted on the running gear belt are moved toward the ground from above and then engage therein. Subsequently, the soil cultivation tools are guided through the intermediate space between two plants in engagement with the ground and then raised vertically upward.

The functions of a deflecting means for deflecting the tool carrier unit described with reference to a crowning plate can also be fulfilled by a cam track. Cam tracks are available in various designs that are familiar to a person skilled in the art.

According to another preferred embodiment, the deflecting means for deflecting the circulating running gear belt is a means for tilting the rotational axes of the deflection rollers. It will be described in greater detail below with reference to the figures that an oppositely directed tilting movement of the rotational axes of the two deflection rollers makes it possible to guide the running gear belt in such a way that the soil cultivation tools mounted thereon are moved toward the ground from above, subsequently engage into the soil in the intermediate space between two plants of a row of plants and then are raised upward.

It is preferred to provide at least one drive unit for carrying out a movement of the first and/or the second actuating means and/or the third actuating means. This drive unit preferably is an actuating drive that can be activated electrically or hydraulically by means of a control device. In this way, the movement of the actuating means can also be realized from the tractor during soil cultivation.

An electric actuating drive may advantageously comprise a gear motor that is arranged on the frame and connected to the respective actuating means, e.g., by means of a belt drive or chain drive. A hydraulic drive, which is particularly advantageous with respect to the energy supply and therefore very well suited for also driving large soil cultivation devices with a plurality of processing units, may comprise a hydraulic cylinder that is arranged on the frame and can be simultaneously used for carrying out a movement of the first and/or the second actuating means and/or the third actuating means.

The drive means for driving the tool carrier unit and/or the means for driving the drive belt running gear and/or the drive unit for carrying out a movement of the first and/or the second and/or the third actuating means preferably is an electric or hydraulic drive that can be activated by means of a control device. The control device preferably is a computer unit. An electric drive may advantageously comprise a gear motor that is arranged on the frame and connected to the respective tool carrier unit, the drive belt running gear or the respective actuating means, for example, by means of a belt drive or chain drive. A hydraulic drive, which is particularly advantageous with respect to the energy supply and therefore very well suited for also driving large soil cultivation devices with a plurality of processing units, may comprise a hydraulic cylinder that is arranged on the frame and can be simultaneously used for carrying out a movement of the tool carrier unit and/or a movement of the drive belt running gear and/or a movement of the first and/or the second and/or the third actuating means or a movement of the first and/or the second actuating means and/or the third actuating means.

It is particularly preferred that the at least one processing unit has two tool carrier units. If the two tool carrier units are positioned in a correspondingly offset manner in the traveling direction, they can engage into the respective intermediate space between two plants of a row of plants similar to a zipper. In this way, an additionally improved and more intensive control of weeds is achieved with high cultivating speed and the cultivated plants are simultaneously protected.

It is particularly preferred that the two tool carrier units of a processing unit are two belt running gears, wherein the respectively cultivated row of plants is arranged between the two belt running gears while the soil cultivation device is in use, wherein a deflecting means for deflecting the respective running gear belt is assigned to each of the two belt running gears, and wherein the two circulating running gear belts can be deflected in opposite directions transverse to the traveling direction by the two deflecting means. The two crowning plates deflect the two running gear belts in opposite directions such that they can engage into the respective intermediate space between two plants of a row of plants from opposite directions. The two belt running gears are offset relative to one another in the traveling direction in order to prevent collisions of the soil cultivation tools and also the running gear belts.

According to a particularly preferred embodiment of the present invention, two deflecting means for deflecting the tool carrier unit are respectively assigned to one or more tool carrier units. These deflecting means may be two identical or two different deflecting means. For example, a hydraulic actuating means may be combined, for example, with a deflecting means for deflecting the tool carrier unit in the form of a crowning plate in this embodiment. In this case, the hydraulic actuating means carries out, for example, the pivoting movement of a partial region of the tool carrier unit in a direction transverse to the traveling direction, which is required after the positioning of the processing unit in the traveling direction, such that the angle between the tool direction and the traveling direction is adjusted to a value between 90° and 180°. The required vertical movement of the soil cultivation tools during cultivation of the row of plants can be realized by means of the crowning plate. The crowning plate naturally can also cause an additional deflection of a partial region of the tool carrier unit in a direction transverse to the traveling direction.

It is particularly preferred that a jogging motor is assigned to each processing unit. The jogging motor makes it possible to comminute larger chunks of soil such that the regrowth of weeds is respectively curtailed or prevented entirely.

According to a particularly preferred embodiment, a deflecting means for deflecting the tool carrier unit in the form of a second hydraulic actuating means is assigned to each tool carrier unit. It was determined that a hydraulic actuating means is most suitable for the pivoting movement of a partial region of the tool carrier unit in a direction transverse to the traveling direction, which is required after the positioning of the processing unit in the traveling direction. It was furthermore determined that the results of the soil cultivation are most favorable with a tool carrier unit that is pivoted over the row of plants.

As mentioned above, the suitable selection of the angle between the tool direction and the traveling direction makes it possible for the soil cultivation tools to have a reduced speed relative to the ground during their engagement into the soil. The relative speed of the soil cultivation tool basically decreases when the angle between the tool direction and the traveling direction approaches the value of 180°. The tractor and the soil cultivation tools move in a diametrically opposite manner if the value amounts to exactly 180°. In this case, the speed of the soil cultivation tool relative to the ground amounts to zero if the speed of the soil cultivation tool corresponds to the speed of the tractor.

The soil cultivation tool moves relative to the ground if the angle between the tool direction and the traveling direction is changed to a value between 180° and 90° while the speeds of the soil cultivation tool and the tractor remain unchanged. Any deviation from 180° leads to a decreasing movement component of the soil cultivation tool diametrically opposite to the traveling direction of the tractor and to an increasing movement component of the soil cultivation tool transverse to the traveling direction, i.e. in a direction transverse to the row of cultivated plants. If the processing unit is positioned accordingly, this movement component of the soil cultivation tool extends through the intermediate space between two successive cultivated plants transverse to the traveling direction.

In this context, it is indicative that the speed of the soil cultivation tool relative to the ground is very low because the majority of the movement component of the soil cultivation tool still extends diametrically opposite to the traveling direction of the tractor. The soil cultivation tool therefore engages into the soil slowly and with little momentum, which in turn leads to the above-described advantage that less soil is ejected and the soil between the plants of a row of cultivated plants is preserved.

An even greater advantage can be seen in the fact that the tractor can be moved forward with a significantly higher speed than in solutions known from the prior art. The speed of the tool carrier and therefore the speed of the soil cultivation tools can be easily adapted to the speed of the tractor over a broad range. However, the relative speed of the soil cultivation tool during its engagement and movement through the ground remains slow and is still associated with the above-described advantages even if the speed is increased.

Under these general conditions, the following ranges for the angle α between the tool direction and the traveling direction proved particularly advantageous: 120°<α<180°, preferably 150°<α<180°, particularly 160°<α<180°, especially 165°<α<175°.

Analogously, the following ranges for the angle β between the circular disk and the traveling direction are particularly advantageous: 120°<β<180°, preferably 150°<β<180°, particularly 160°<β<180°, especially 165°<β<175°.

Ultimately, the following ranges for the angle γ between the elongate deflection roller connecting means and the traveling direction are particularly advantageous: 120°<γ<180°, preferably 150°<γ<180°, particularly 160°<γ<180°, especially 165°<γ<175°.

### BRIEF DESCRIPTION OF THE DRAWINGS

Exemplary embodiments of the invention are described in greater detail below with reference to the drawings. However, it is expressly noted that the invention is not limited to the described examples. In the drawings,

FIG. 1 shows a schematic top view of a soil cultivation device according to the invention with a tractor;

FIG. 2 shows a schematic top view of an embodiment of a processing unit of a soil cultivation device according to the invention;

FIG. 3 shows a schematic top view of another embodiment of a processing unit of a soil cultivation device according to the invention;

FIG. 4 shows a schematic top view of another embodiment of a processing unit of a soil cultivation device according to the invention;

FIG. 5A shows a schematic side view of another embodiment of a processing unit of a soil cultivation device according to the invention;

FIG. 5B shows a schematic top view of the embodiment according to FIG. 5A;

FIG. 6 shows a schematic top view of another embodiment of a processing unit of a soil cultivation device according to the invention;

FIG. 7 shows a schematic top view of another embodiment of a processing unit of a soil cultivation device according to the invention; and

FIG. 8 shows a schematic top view of another embodiment of a processing unit of a soil cultivation device according to the invention.

### DETAILED DESCRIPTION

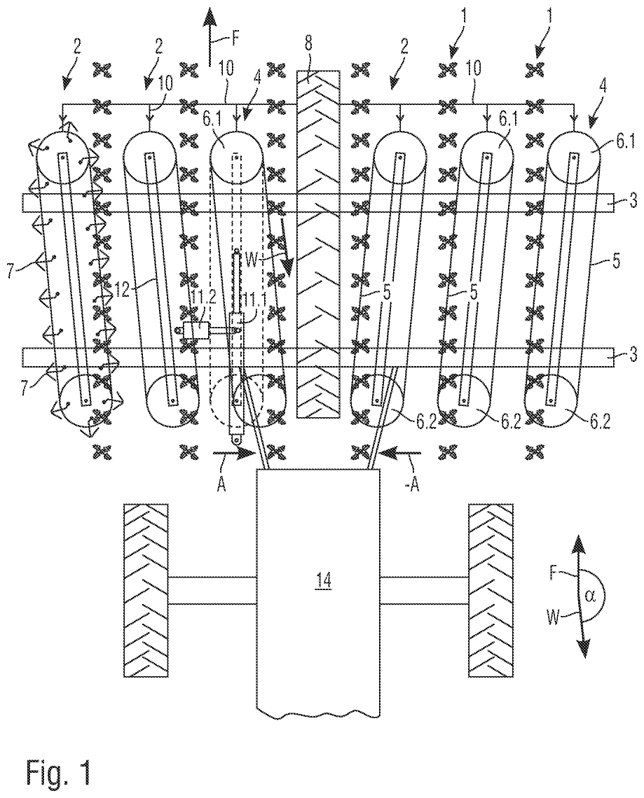

FIG. 1 shows a schematic top view of a soil cultivation device for mechanical weed control in rows of cultivated plants 1 according to the invention with a tractor 14. The soil cultivation device comprises a frame 3 that is attached to the tractor 14 for movement along a traveling direction F, wherein the frame 3 is merely indicated by two frame tubes. Other elements of the frame 3 are not necessary for the description of the invention and therefore not illustrated in the figures. Six processing units 2 with a respective tool carrier unit 4 are arranged on the frame 3. The soil cultivation device has six identical processing units 2 in the exemplary embodiment shown.

According to the invention, soil cultivation within a row of cultivated plants 1 takes place in the region between the individual cultivated plants 1. In addition to the means required for this type of soil cultivation, the soil cultivation device according to the present invention may be optionally equipped with additional means and tools that also allow soil cultivation in the lane between two rows of cultivated plants. In this case, weed control can be simultaneously carried out between the rows of cultivated plants and within a row of cultivated plants.

Each of the processing units 2 has a tool carrier unit 4 with a plurality of soil cultivation tools 7 arranged on the tool carrier unit 4. In the exemplary embodiment illustrated in FIG. 1, the tool carrier units 4 are respectively realized in the form of a belt running gear with an endlessly circulating running gear belt 5 and two deflection rollers 6.1, 6.2. The plurality of soil cultivation tools 7 is arranged on the running gear belt 5 with a constant distance from one another. The soil cultivation tools 7 are realized in the form of cultivator sweeps, in the embodiment shown. The soil cultivation device has a drive means 8 for driving the belt running gears. The individual running gear belts 5 are moved by driving the belt running gears 4 such that the soil cultivation tools 7 are moved along an endlessly circulating path.

The drive means 8 is configured and designed in such a way that the running gear belts 5 can be moved with a speed, which is adapted to the speed of the tractor 14 in the traveling direction F in such a way that the soil cultivation tools 7 engage exclusively into regions between two successive cultivated plants 1 of a row of cultivated plants 1 during their endlessly circulating movement.

In FIG. 1, the drive means 8 for driving the tool carrier unit 4 is realized in the form of a drive belt running gear that is arranged on the frame 3 attached to the tractor 14. The drive belt running gear 8 is in contact with the ground over a partial circumferential area and moved due to friction with the ground. As a first approximation, the circumferential speed of the drive belt running gear 8 corresponds to the speed of the tractor 14 in this case. The movement of the drive belt running gear 8 is transmitted to the plurality of deflection rollers 6.1 by means of any transmission or coupling means 10 familiar to a person skilled in the art.

Each of the processing units 2 ultimately has a deflecting means 11.2 for deflecting the tool carrier unit 4. Only one of these deflecting means 11.2 is illustrated in FIG. 1 in order to provide a better overview. However, all processing units 2 are provided with such a deflecting means 11.2. It is realized in the form of a hydraulic actuating means, which is equipped with a (not-shown) electric drive that can be activated by means of a control device (computer unit). This electric drive causes a movement of the actuating means such that a partial region of the belt running gear 4 is deflected in a direction A transverse to the traveling direction F. In the exemplary embodiment illustrated in FIG. 1, the deflection roller 6.1 is fixed whereas the deflection roller 6.2 is realized in a pivotable manner. In FIG. 1, one of the belt running gears 4 is illustrated with broken lines in its original position. The hydraulic actuating means 11.2 pivots the belt running gear into the position illustrated with continuous lines in FIG. 1.

In the exemplary embodiment illustrated in FIG. 1, the hydraulic actuating means 11.2 pivot three of the belt running gears 4 in a direction A transverse to the traveling direction F whereas three of the belt running gears 4 are pivoted in the opposite direction −A transverse to the traveling direction F.

When the soil cultivation tools 7 are moved in the section of their endlessly circulating path near the ground, this is realized due to the circulation of the respective running gear belt 5 in such a way that the soil cultivation tools 7 are moved in the tool direction W. The tool direction W and the traveling direction F include an angle α that is illustrated in the lower right portion of FIG. 1, wherein α=170°.

FIG. 1 shows another hydraulic actuating means 11.1, wherein this hydraulic actuating means 11.1 makes it possible to realize a movement of the belt running gear in the traveling direction F. In this way, the soil cultivation tools 7 can be positioned relative to the cultivated plants, i.e. in a respective intermediate space between two cultivated plants of a row, prior to the beginning of soil cultivation.

The soil cultivation device furthermore comprises a camera and a computer unit, wherein the computer unit is designed and configured for processing the image information recorded by the camera. These elements are not illustrated in FIG. 1 in order to provide a better overview.

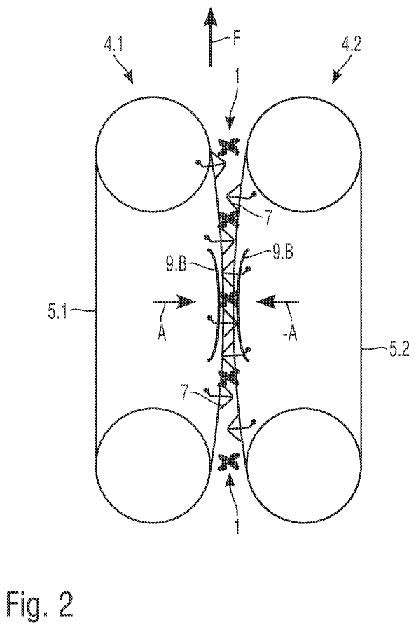

FIG. 2 shows a schematic top view of another embodiment of a processing unit of a soil cultivation device according to the invention. In this case, the processing unit has two tool carrier units, namely the two belt running gears 4.1, 4.2. The respective row of plants 1 to be cultivated is arranged between the two belt running gears 4.1, 4.2 while the soil cultivation device is in use. A deflecting means for deflecting the respective running gear belt, namely a respective crowning plate 9.B, is assigned to each of the two belt running gears 4.1, 4.2.

According to FIG. 2, the two crowning plates 9.B cause a deflection of the two circulating running gear belts 5.1, 5.2 in opposite directions A, −A transverse to the traveling direction F. Consequently, the soil cultivation tools 7 engage into the respective intermediate space between two plants of a row of plants from opposite directions A, −A similar to a zipper. Since the running gear belts 5.1, 5.2 are guided along the crowning plates 9.B, the soil cultivation tools 7 mounted on the running gear belts 5.1, 5.2 are moved toward the ground from above and then engage therein. Subsequently, the soil cultivation tools 7 are guided through the intermediate space between two cultivated plants 1 in engagement with the ground and then raised vertically upward in order to prevent damages to the next cultivated plant 1.

In the embodiment shown a deflection of only the running gear belts 5.1, 5.2 takes place. The two (not-shown) deflection roller connecting means remain aligned in their position parallel to the row of plants 1. The deflection of the crowning plates 9.B transverse to the traveling direction F is realized with the aid of (not-shown) hydraulic actuating means. The two belt running gears 4.1, 4.2 are arranged offset relative to one another in the traveling direction F in order to prevent collisions of the soil cultivation tools and also the running gear belts 5.1, 5.2. This embodiment makes it possible to achieve an additionally improved and more intensive control of weeds with high cultivating speed and the cultivated plants are simultaneously protected.

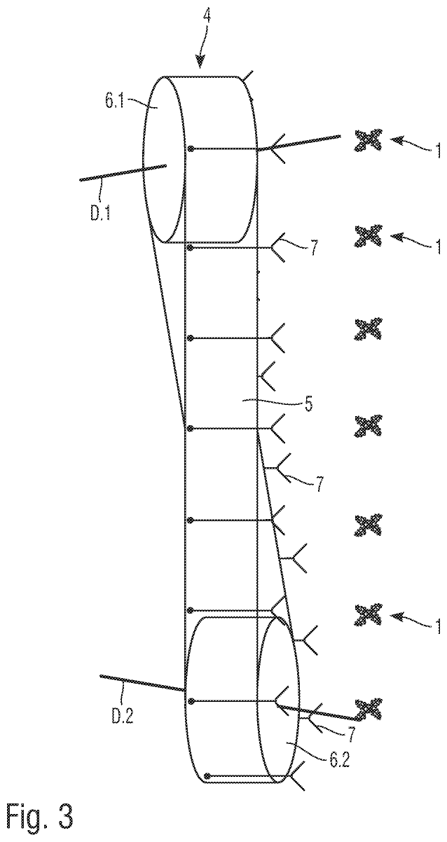

FIG. 3 shows a schematic top view of another embodiment of a processing unit of a soil cultivation device according to the invention. The processing unit has a tool carrier unit, namely the belt running gear 4. In this case, the deflecting means for deflecting the circulating running gear belt 5 is realized in the form of a means for tilting the rotational axes D.1, D.2 of the deflection rollers 6.1, 6.2. An oppositely directed tilting movement of the rotational axes D.1, D.2 of the two deflection rollers 6.1, 6.2 makes it possible to guide the running gear belt 5 in such a way that the soil cultivation tools 7 mounted on the running gear belt 5 are moved toward the ground from above, subsequently engage into the soil in the intermediate space between two cultivated plants of a row of plants 1, and then are raised upward.

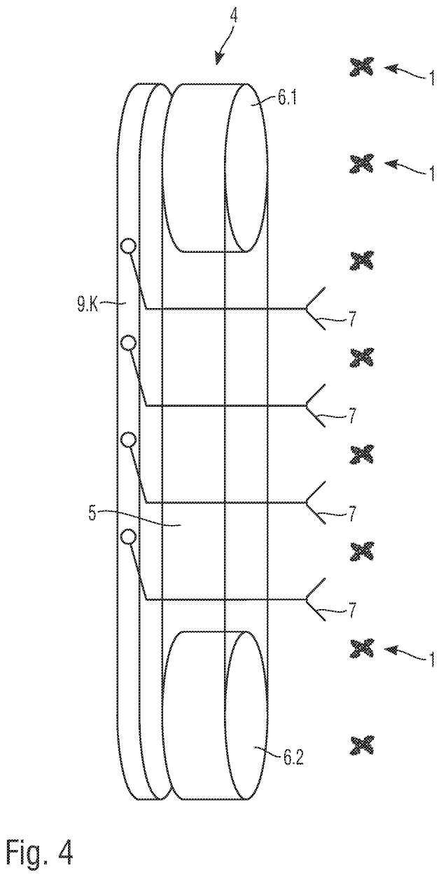

FIG. 4 shows a schematic top view of another embodiment of a processing unit of a soil cultivation device according to the invention. The processing unit has a tool carrier unit 4, namely a belt running gear 4. In this case, the deflecting means for deflecting the circulating running gear belt 5 is realized in the form of a cam track 9.K. Cam tracks are available in various designs that are familiar to a person skilled in the art. The soil cultivation tools 7 mounted on the running gear belt 5 are guided in the cam track 9.K. Only a section of the cam track 9.K is schematically indicated in FIG. 4.

The (not-shown) deflection roller connecting means can remain aligned in its position parallel to the row of plants because the running gear belt 5 is likewise deflected due to the engagement of the soil cultivation tools 7 into the cam track 9.K. However, an additional pivoting movement of the deflection roller connecting means and therefore the entire belt running gear transverse to the traveling direction is basically also possible. The engagement of the soil cultivation tools 7 into the region between the cultivated plants 1 of a row of plants can be realized due to the purposeful deflection of the running gear belt. A correspondingly shaped cam track 9.K makes it possible to deflect the running gear belt 5 in a direction transverse to the traveling direction, i.e. transverse to the row of plants, but also in a direction vertically downward or upward. Since the soil cultivation tools 7 are guided in the cam track 9.K, they are initially moved toward the ground from above and then engage therein. Subsequently, the soil cultivation tools 7 are guided through the intermediate space between two cultivated plants 1 in engagement with the ground and then raised vertically upward.

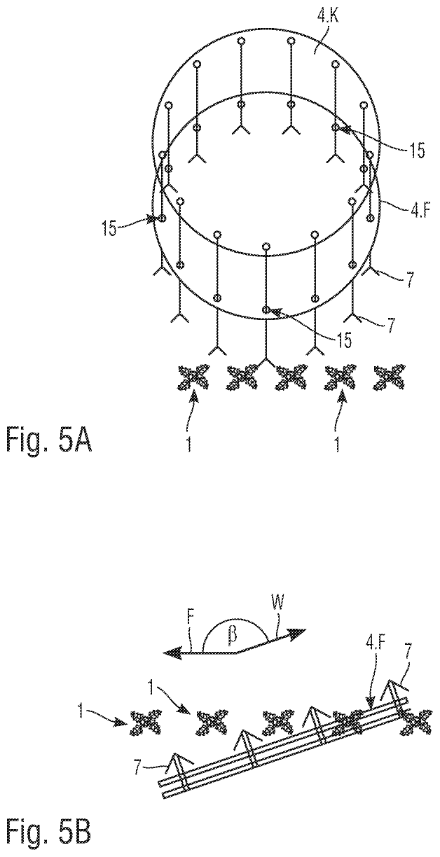

FIG. 5A shows a schematic side view of another embodiment of a processing unit of a soil cultivation device according to the invention. FIG. 5B shows a top view of the same embodiment. The processing unit has a tool carrier unit, namely the circular disk 4.K (which is illustrated transparently in FIG. 5A). The deflecting means for deflecting the circular disk 4.K is realized in the form of a (not-shown) hydraulic actuating means. The circular disk is deflected in such a way that the circular disk includes an angle β with the traveling direction, wherein β=160°. In this case, the circular disk is deflected transverse to the traveling direction in such a way that it protrudes beyond the row of plants to be cultivated.

A plurality of soil cultivation tools 7 is fastened on the circular disk 4.K. At the beginning of cultivation, a (not-shown) drive means for driving the circular disk 4.K sets the circular disk in rotation in such a way that the angle between the tool direction and the traveling direction amounts to 160°. The angle between the traveling direction and the tool direction therefore always corresponds to the angle β between the vertical projection of the circular disk on the ground and the traveling direction.

A circular guide disk 4.F is furthermore provided, wherein each of the soil cultivation tools 7 is guided by a respective recess 15 provided in the circular guide disk 4.F. The circular disk 4.K and the circular guide disk 4.F have identical diameters. The centers of the circular disk 4.K and the circular guide disk 4.F lie in a common plane perpendicular to the ground, wherein the radius of the circular disk 4.K, which is oriented vertically on the ground, also lies in this plane. The two circular disks 4.K, 4.F are arranged slightly offset to one another and largely overlap in the projection perpendicular to the surface of the circular disk 4.K.

Each of the soil cultivation tools 7 is movably mounted on the circular disk 4.K with the aid of a ball joint. The circular guide disk 4.F has a number of recesses 15 that corresponds to the number of soil cultivation tools 7. The spacing between these recesses 15 is identical to the spacing between the mounting points of the soil cultivation tools 7 on the circular disk 4.K. Each of the soil cultivation tools 7 mounted on the circular disk 4.K is guided by one respective recess 15 of the circular guide disk 4.F. As a result, the soil cultivation tools 7 do not point radially outward during a rotation of the circular disk 4.K, but rather are always oriented in the direction to the ground. The speed of the soil cultivation tools 7 therefore decreases due to the reduction of the circumference of the circular path, on which the part of the soil cultivation tools 7 engaging into the soil moves.

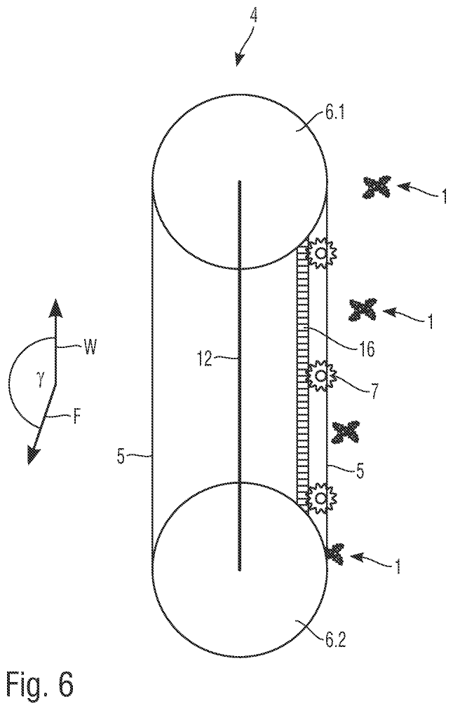

FIG. 6 shows a schematic top view of another embodiment of a processing unit of a soil cultivation device according to the invention. The processing unit has a tool carrier unit, namely the belt running gear 4. The deflecting means for deflecting the circulating running gear belt 5 is realized in the form of a (not-shown) hydraulic actuating means. A movement of the hydraulic actuating means is realized, for example, with the aid of an electric drive in order to thereby deflect at least a partial region of the belt running gear 4 in a direction A transverse to the traveling direction F. When the soil cultivation tools 7 are moved in the section of their endlessly circulating path near the ground, this is realized due to the circulation of the respective running gear belt 5 in such a way that the soil cultivation tools 7 are moved in the tool direction W. The tool direction W and the traveling direction F include an angle γ that is illustrated in FIG. 6, wherein γ=160°.

The processing unit according to FIG. 6 is additionally equipped with a gear rack 16 that is suitably mounted on the processing unit. The soil cultivation tools 7 are respectively equipped with a gear wheel. As the soil cultivation tools 7 circulate while being guided by the running gear belt 5, they engage into the gear rack 16 with their gear wheel and are thereby set in rotation. According to FIG. 6, this takes place in the section, in which the soil cultivation tools 7 engage into the soil between the plants. Weeds are uprooted and turned with additionally improved effectiveness and efficiency due to the rotational movement of the soil cultivation tools 7.

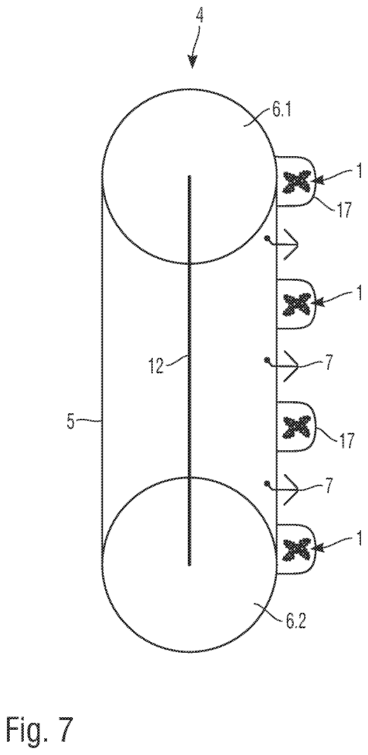

FIG. 7 shows a schematic top view of an embodiment of a processing unit of a soil cultivation device, which is designed analogous to the embodiment illustrated in FIG. 2. The processing unit has two tool carrier units, but only one tool carrier unit, namely the belt running gear 4, is illustrated in the figure. The respective row of plants 1 to be cultivated is arranged between the two belt running gears while the soil cultivation device is in use. The semicircles 17 symbolize cup-like covers that are mounted on the running gear belt 5. As the soil cultivation tools 7 circulate, the cover 17 places itself over a cultivated plant 1 and protects it from soil that would otherwise be thrown on the plants 1 by the soil cultivation tools 7.

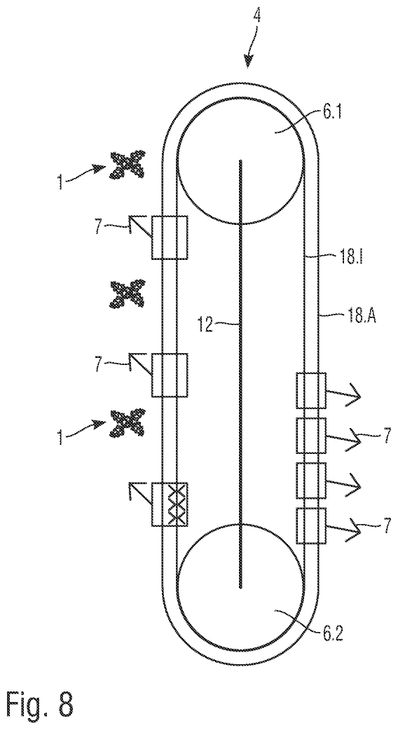

FIG. 8 shows a schematic top view of another embodiment of a processing unit of a soil cultivation device according to the invention. The processing unit has a tool carrier unit, namely the belt running gear 4. In this case, the belt running gear is formed by two link chains 18.1, 18.A, wherein the inner link chain 18.1 is moved with a speed that corresponds to the speed of the tractor. The outer link chain 18.A is moved slightly faster such that the soil cultivation tools 7 can be transported into a standby position as illustrated in FIG. 8. The soil cultivation tools 7 engage into the inner link chain 18.1 and carry out the soil cultivation upon a corresponding command of the computer unit.

1. A soil cultivation device for mechanical weed control in rows of cultivated plants, the soil cultivation device comprising:
a frame attachable to a tractor for movement along a traveling direction (F); and
at least one processing unit attached to the frame,
wherein the at least one processing unit has at least one tool carrier unit with at least one soil cultivation tool arranged on the at least one tool carrier unit,
wherein at least one deflecting means is provided for deflecting the at least one tool carrier unit, wherein a deflection of at least a partial region of the at least one tool carrier unit in at least a direction (A, −A) transverse to the traveling direction (F) can be realized with the aid of the at least one deflecting means,
wherein the soil cultivation device has at least one drive means for driving the at least one tool carrier unit,
wherein the at least one soil cultivation tool can be moved on an endlessly circulating path due to a movement of the at least one tool carrier unit, wherein the at least one drive means for driving the at least one tool carrier unit is configured in such a way that the at least one tool carrier unit can be moved with a speed, which is adapted to the speed of the tractor in the traveling direction (F), in such a way that the at least one soil cultivation tool engages into regions between two successive cultivated plants of a row of cultivated plants, wherein the at least one soil cultivation tool can be moved in a tool direction (W) in a section of the endlessly circulating path near the ground, wherein the tool direction (W) is at an angle α relative to the traveling direction (F), and wherein α satisfies a condition 90°<α<180°,
wherein the at least one tool carrier unit forms a circular disk, wherein the at least one drive means for driving the at least one tool carrier unit is a drive means for driving the circular disk, wherein the circular disk is set in rotation by the drive means, wherein the at least one deflecting means for deflecting the at least one tool carrier unit is a deflecting means for deflecting the circular disk, wherein the circular disk can be deflected in a direction (A, −A) transverse to the traveling direction (F) by the deflecting means,
wherein the deflection of the circular disk can be realized in such a way that the circular disk is at an angle β relative to the traveling direction (F), wherein β satisfies a condition 90°<β<180°, and wherein α=β, and
wherein a circular guide disk is provided, wherein the at least one soil cultivation tool is guided by a recess provided in the circular guide disk.

2. (canceled)

3. (canceled)

4. (canceled)

5. (canceled)

6. (canceled)

7. The soil cultivation device according to claim 1, wherein a plurality of the at least one soil cultivation tool is arranged on the at least one tool carrier unit a constant distance from one another.

8. The soil cultivation device according to claim 1, wherein the at least one drive means for driving the at least one tool carrier unit is a depth control wheel, which is arranged on the frame attached to the tractor and serves for controlling a working depth, wherein the depth control wheel is mechanically coupled to the at least one tool carrier unit.

9. (canceled)

10. (canceled)

11. The soil cultivation device according to claim 1, wherein a plurality of the at least one processing unit with a plurality of the at least one tool carrier unit is arranged on the frame.

12. (canceled)

13. The soil cultivation device according to claim 1, wherein the at least one soil cultivation tools are harrow tines or cultivator sweeps.

14. The soil cultivation device according to claim 1, wherein the at least one processing unit has at least one first hydraulic actuating means, wherein the at least one tool carrier unit can be moved parallel to the traveling direction (F) by the at least one first hydraulic actuating means.

15. The soil cultivation device according to claim 1, wherein the at least one processing unit has at least one second hydraulic actuating means, wherein at least a partial region of the at least one tool carrier unit can be moved in a direction (A, −A) transverse to the traveling direction (F) by the at least one second hydraulic actuating means.

16. (canceled)

17. The soil cultivation device according to claim 8, wherein the at least one deflecting means for deflecting the at least one tool carrier unit is the at least one second hydraulic actuating means.

18. (canceled)

19. (canceled)

20. (canceled)

21. (canceled)

22. The soil cultivation device according to claim 1, wherein the at least one drive means for driving the at least one tool carrier unit is an electric or hydraulic drive that can be activated by means of a control device.

23. The soil cultivation device according to claim 1, wherein the at least one processing unit has two tool carrier units.

24. (canceled)

25. The soil cultivation device according to claim 1, wherein two deflecting means are assigned to the at least one tool carrier unit in order to deflect the at least one tool carrier unit, wherein the two deflecting means are two identical or two different deflecting means.

26. (canceled)

27. The soil cultivation device according to claim 1, wherein the at least one deflecting means for deflecting the at least one tool carrier unit in a form of a second hydraulic actuating means is assigned to each of the at least one tool carrier unit.

28. The soil cultivation device according to claim 1, wherein α satisfies a condition 120°<α<180°.

29. The soil cultivation device according to claim 1, wherein β satisfies a condition 120°<β<180°.

30. (canceled)
